(19) United States
(12) Patent Application Publication
(10) Pub. No.: US 2009/0146962 A1
(43) Pub. Date: Jun. 11, 2009

(54) MOBILE COMMUNICATION TERMINAL AND METHOD

(75) Inventors: Petri Antero AHONEN, Jyvaskyla (FI); Erkki Lauri KURKINEN, Puuppola (FI); Pasi Antero KAIPAINEN, Jyvaskyla (FI); Henrik BRUSGAARD, Charlottenlund (DK)

Correspondence Address: PERMAN & GREEN, 425 POST ROAD, FAIRFIELD, CT, 06824, US

(73) Assignee: NOKIA CORPORATION, Espoo (FI)

(21) Appl. No.: 11/950,799

(22) Filed: Dec. 5, 2007

(51) Int. Cl. G06F 3/041

(52) U.S. Cl. 345/173

(57) ABSTRACT

A device including a display, a memory and a tap detector arranged to generate a detection signal upon detection of a tap command. The device is arranged to assume either an idle state, in which the display is inactive, or a second state, in which the display is active and displaying information stored in the memory. The device is arranged to transit from the idle state to the second state when a tap is detected i.e. upon generation of the detection signal.

### CROSS-REFERENCE TO RELATED APPLICATIONS

This application claims priority to and the benefit of U.S. patent application Ser. No. 11/622,604, filed 12 Jan. 2007, still pending.

The disclosed embodiments generally relate to mobile terminals and more particularly to user input of mobile terminals.

### BACKGROUND

Mobile terminals, or mobile (cellular) telephones, for mobile telecommunications systems like GSM, UMTS, D-AMPS and CDMA2000 have been used for many years now. In the older days, mobile terminals were used almost exclusively for voice communication with other mobile terminals or stationary telephones. More recently, the use of modern terminals has been broadened to include not just voice communication, but also various other services and applications such as www/wap browsing, video telephony, electronic messaging (e.g. SMS, MMS, email, instant messaging), digital image or video recording, FM radio, music playback, exercise analysis, electronic games, calendar/organizer/time planner, word processing, etc.

More and more electronic devices such as mobile phones, MP3 players, Personal Digital Assistants (PDAs) are becoming smaller and smaller while having more and more information stored and/or accessible through them. Users are relying on these devices and becoming all the more dependent on them. Due to the devices' complexity they also have high power consumption and as they are designed to be small and easy to carry around the power consumption becomes an issue of importance.

The environments in which these devices are used are also becoming more and more hectic with higher demands on fast access and multitasking, and not only in a professional environment but also in private and social environments. For example a user should be able to read a book, while holding a grocery bag in a rattling subway train and still be able to access the information stored in the device for the device to live up to the many requirements posed upon it by a user buying and using the device.

One problem with devices such as mobile terminals is inadvertent actuation of keys of the keypad. This can result in undesired phone calls, or even worse, deletion of content in the mobile terminal, such as phone book records or photographs.

In the prior art, it is known to allow the user to lock the keypad to reduce the risk of inadvertent key actuations. However, when unlocking the keypad, the key sequence is often awkward with keys needed to be pressed in a certain sequence, to reduce the risk of inadvertent unlocking of the keypad.

Another problem in the prior art is with using the mobile terminal as a clock to tell the time. To allow this functionality, the terminal always shows the time, even when the keypad is locked. The problem with this is that power is used to show the time even though most of the time the user does not actually look at the display.

Consequently, there is a need to provide a mobile communication terminal and method providing a user interface which is easier to use in conjunction with keypad locking.

Also a device that always has all its information available would be useful in modern day society, but due to the power needed to keep all the features of the device active and the size of the screen needed to display all the information at once would make this device too big to be easy to carry around.

### DISCLOSURE

On this background, the aspects of the disclosed embodiments provide a device and a method that overcomes or at least reduces the drawbacks indicated above by providing a device having reduced power consumption with a fast, easy and intuitive way of accessing information stored on or accessible through the device, even information relating to different applications, and also giving intuitive access to many of these applications and their data.

According to a first aspect there has been provided a method for providing a user interface of a mobile communication terminal comprising a motion sensitive sensor, a keypad and a display, the mobile communication terminal being capable of being in at least an active mode and a key-lock mode, the method comprising: detecting, using the motion sensitive sensor, a first user input indicating a desire to switch modes; when the mobile communication terminal is in the active mode, as a response to the first user input, switching the mobile communication terminal to the key-lock mode; and when the mobile communication terminal is in the key-lock mode, as a response to the first user input, switching the mobile communication terminal to the active mode. Consequently, the user can switch modes simply by effecting a movement of the mobile communication terminal.

The detecting the first user input may involve detecting at least one tap on the mobile communication terminal. One or more taps is an easy user action requiring little user precision and can as such be actuated by the user while on the move.

The method may comprise, after the detecting, presenting a user indication prompting for confirmation to switch the modes of the mobile communication terminal; and detecting a second user input.

In the presenting the user indication, a clock may be presented on the display.

In the presenting the user indication, a single pulse vibration alert may be generated. Tactile feedback is both noticeable and discrete.

The second user input may be interpreted as a confirmation to switch modes.

The second user input being associated with switching modes may be an actuation of a key of the keypad.

The method may further comprise prior to the switching: ending the method when the second user input is associated with ending the method.

The method may further comprise prior to the switching: ending the method when a user input fails to be detected during a time-out period.

The method may further comprise: when switching is performed, generating a double pulse vibration alert.

In the below a mode is construed to be an implementation of a state, a composite state or collection of states in a device, such as a mobile terminal or mobile phone, depending on the complexity of the functionalities (if any) of the mode. A mode switch is thus a transit from one state to another state, both states possibly being composite states.

A second aspect of the disclosed embodiments is a method for providing a user interface of a mobile communication terminal comprising a motion sensitive sensor, and a display, the method comprising: detecting using the motion sensitive sensor, a first user input; and as a response to the first user input, presenting a clock on the display. This allows the user to, in a simple way, instruct the mobile communication terminal to show a clock, reducing the need to provide a clock in key-lock mode, and thereby conserving battery power.

The detecting the first user input may involve detecting at least one tap on the mobile communication terminal.

The mobile communication terminal may be capable of being in at least an active mode and a key-lock mode, and the mobile communication terminal may be in the key-lock mode when the method is commenced, and the method may further comprise, after the presenting: detecting a second user input indicating a desire to switch to the active mode; and as a response to the first user input, switching the mobile communication terminal to the active mode.

The second user input may comprise a double tap of the mobile communication terminal.

A third aspect of the disclosed embodiments is a method for providing a user interface of a mobile communication terminal comprising a motion sensitive sensor, a keypad and a display, the mobile communication terminal being capable of being in at least an active mode and a key-lock mode, the method comprising: detecting, while the mobile communication terminal is in the active mode, using the motion sensitive sensor, a first user input indicating a desire to switch to the key-lock mode; and as a response to the first user input, switching the mobile communication terminal to the key-lock mode.

A fourth aspect of the disclosed embodiments is an apparatus being capable of being in at least an active mode and a key-lock mode, the apparatus comprising: a display; a keypad; a motion sensitive sensor; and a controller; wherein the controller is configured to detect, using the motion sensitive sensor, a first user input indicating a desire to switch modes; and the controller is further configured to, as a response to the first user input, when the apparatus is in the active mode, switch the apparatus to the key-lock mode, and the controller is further configured to, as a response to the first user input, when the apparatus is in the key-lock mode, switch the apparatus to the active mode.

The motion sensitive sensor may comprise a sensor selected from the group consisting of a tilt sensor and an accelerometer, or any combination of the above.

The apparatus may be comprised in a mobile communication terminal.

A fifth aspect of the disclosed embodiments is an apparatus being capable of being in at least an active mode and a key-lock mode, the apparatus comprising: a display; a keypad; a motion sensitive sensor; a controller; means for detecting, using the motion sensitive sensor, a first user input indicating a desire to switch modes; and means for, when the apparatus is in the active mode, as a response to the first user input, switching the apparatus to the key-lock mode, and means for, when the apparatus is in the key-lock mode, as a response to the first user input, switching the apparatus to the active mode.

A sixth aspect of the disclosed embodiments is an apparatus comprising: a display; a motion sensitive sensor; and a controller; wherein the controller is configured to detect, using the motion sensitive sensor, a first user input; and the controller is further configured to, as a response to the first user input, presenting a clock on the display. The apparatus may be comprised in a mobile communication terminal.

A seventh aspect of the disclosed embodiments is an apparatus comprising: a display a motion sensitive sensor; a controller; means for detecting using the motion sensitive sensor, a first user input; and means for, as a response to the first user input, presenting a clock on the display.

An eighth aspect of the disclosed embodiments is an apparatus being capable of being in at least an active mode and a key-lock mode, the apparatus comprising: a display; a keypad; a motion sensitive sensor; and a controller; wherein the controller is configured to detect, while the apparatus is in the active mode, using the motion sensitive sensor, a first user input indicating a desire to switch to the key-lock mode; and the controller is further configured to, as a response to the first user input, switch the apparatus to the key-lock mode. The apparatus may be comprised in a mobile communication terminal.

A ninth aspect of the disclosed embodiments is an apparatus being capable of being in at least an active mode and a key-lock mode, the apparatus comprising: a display; a keypad; a motion sensitive sensor; a controller; means for detecting, while the apparatus is in the active mode, using the motion sensitive sensor, a first user input indicating a desire to switch to the key-lock mode; and means for, as a response to the first user input, switching the apparatus to the key-lock mode.

A tenth aspect of the disclosed embodiments is a computer program product comprising software instructions that, when executed in a mobile communication terminal, performs the method according to the first aspect.

An eleventh aspect of the disclosed embodiments is a computer program product comprising software instructions that, when executed in a mobile communication terminal, performs the method according to the second aspect.

A twelfth aspect of the disclosed embodiments is a computer program product comprising software instructions that, when executed in a mobile communication terminal, performs the method according to the third aspect.

According to a thirteenth aspect, an apparatus or a device is provided comprising a display, a memory and a tap detector arranged to generate a detection signal upon detection of a tap command, wherein said device is arranged to assume one out of a plurality of states including an idle state, wherein said display is inactive, and a second state, wherein said display is active and displaying information stored in said memory. Said device is arranged to transit from said idle state to said second state upon generation of said detection signal.

By bringing a device from an idle inactive state to show information on an otherwise inactive screen with a simple tap provides a very intuitive, easy to use and power efficient manner to allow access to information stored on the device. It finds great use in stressed situations or when movements are required to be quick and precision can not be guaranteed.

In one embodiment the tap detector is a motion sensitive sensor.

In one embodiment the device is further arranged to change said information being displayed on said display upon further generation of said detection signal. This allows a user access to much more information than can be displayed at once on the display while still allowing quick and imprecise movements to control the device.

In one embodiment the information relates to any of time, incoming message status, call history status or calendar events.

In one embodiment the device is further arranged to select which information to display according to availability of said information. By selecting the information to be displayed according to the availability and along certain criteria the information most likely asked for by a user can be displayed at once enabling the user to access the wanted or most pertinent data as quickly as possible while still not being required to make many precise movements.

In one embodiment the tap detector is arranged to generate said detection signal upon detecting any of a single tap, a double tap or alternatively a shake. By having different taps available the device can be safe guarded against accidental activation. Furthermore this enables further and more advanced control of the device.

In one embodiment the device further comprises a third state in which further information is displayed and said device is arranged to transit to said third state from said second state upon generation of an alternative detection signal. A third state such as this offers a user better control of and access to the device still without requiring precise movement. And by requiring a further or alternative detection signal, i.e. a further or alternative tap the device is further safe guarded against accidental activation.

In one embodiment the information being displayed in said second state is different from said further information being displayed in said third state.

In one embodiment the second state is an information providing state in which said device is arranged to display information and said third state is an active state in which said device is arranged to receive further commands associated with functions of said device.

According to a fourteenth aspect a method for providing a user interface of an apparatus or a device having a display comprises: starting in an idle state wherein said display is inactive, detecting a tap, entering a second state and causing said display to display information. As for the device above, this enables a user to quickly access information stored on a device.

In one embodiment the tap detector is a motion sensitive sensor.

In one embodiment the method further comprises detecting a further tap and causing said display to change said information being displayed.

In one embodiment the method further comprises selecting said information to be displayed according to availability of said information.

In one embodiment the method further comprises detecting a further or alternative tap, entering a third stage and causing said display to display further information.

In one embodiment the further information pertains to an activity or a function associated with said and said method further comprises detecting a tap and executing said activity or function.

According to a fifteenth aspect of the disclosed embodiments an apparatus or a device is provided having tap detector means, display means and information storing means, wherein said device is arranged to assume an idle state in which said display means are inactive, and to assume a second state, wherein said display means are active and arranged to display information form said information storing means, wherein said detector tap means are arranged to switch said device from said idle state to said second state upon detection of a tap.

A device such as this has the same benefits as explained for the device and method above.

According to a sixteenth aspect of the disclosed embodiments a computer readable medium is provided including at least computer program code for controlling a device comprising a display, tap detector, said computer readable medium comprising: software code for receiving input through said tap detector software code for activating said display upon receiving input from said tap detector, and software code for causing said display to display information.

This enables a device to benefit from the advantages as described above and also later in the detailed description by executing the software code.

In a seventeenth aspect the disclosed embodiments are directed to a device incorporating and implementing a computer readable medium according to above.

In an eighteenth aspect the disclosed embodiments are directed to a device comprising display means and tap detector means for detecting a tap command from a user and for generating a detection signal upon detection of a tap command, wherein said device comprises means for assuming one out of a plurality of states including an idle state, wherein said display means are inactive, and a second state, wherein said display means are active and displaying information, and said device comprises means for transiting from said idle state to said second state upon generation of said detection signal.

In one embodiment said tap detector means is a motion sensitive sensor.

In one embodiment said device further comprises means for changing said information being displayed on said display means upon further generation of said detection signal whilst the device is in said second state.

In one embodiment said information relates to any from the group comprising time, incoming message status, call history status or calendar events.

In one embodiment said device further comprises means for selecting which information to display according to availability of said information.

In one embodiment said device further comprises a third state and means for displaying further information in said third state and said device comprises means for transiting to said third state from said second state upon generation of an alternative detection signal.

In one embodiment said information being displayed in said second state is different from said further information being displayed in said third state.

In one embodiment said second state is an information providing state in which said device comprises means for displaying information and said third state is an active state wherein said device comprises means for receiving further commands associated with functions of said device.

In a nineteenth aspect the disclosed embodiments are directed to an apparatus comprising: a display; a motion sensitive sensor; and a controller; wherein said controller is configured to detect, using said motion sensitive sensor, a first user input; and said controller is further configured to, as a response to said first user input, activating said display and presenting a clock on said display.

In a twenteeth aspect the disclosed embodiments are directed to an apparatus comprising: a display; a motion sensitive sensor; a controller; means for detecting using said motion sensitive sensor, a first user input; and means for, as a response to said first user input, activating said display and presenting a clock on said display.

In a twenty-first aspect the disclosed embodiments are directed to a method for providing a user interface of a mobile communication terminal comprising a motion sensitive sensor, and a display, said method comprising: detecting using said motion sensitive sensor, a first user input; and as a response to said first user input, activate said display and presenting a clock on said display.

Other features and advantages of the disclosed embodiments will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

In the following detailed portion of the present description, the invention will be explained in more detail with reference to the example embodiments shown in the drawings, in which:

FIG. 1 is a schematic illustration of a cellular telecommunication system, as an example of an environment in which the disclosed embodiments may be applied.

FIG. 2 is a schematic front view illustrating a mobile terminal according to an embodiment.

FIG. 3 is a schematic block diagram representing an internal component, software and protocol structure of the mobile terminal shown in FIG. 2.

FIGS. 4a and 4b are a schematic diagrams showing how modes can be switched in the mobile terminal shown in FIG. 2.

FIG. 5 is a flow chart illustrating a mode switch in the terminal of FIG. 2.

FIG. 6 a, b and c are schematic back views illustrating a device according to an embodiment,

FIG. 7 is a flow chart illustrating a method according to an embodiment,

FIG. 8 is a flow chart illustrating a method according to an embodiment,

FIG. 9 is a flow chart illustrating a method according to an embodiment, and

FIG. 10 is a state diagram for a device according to an embodiment of the application.

### DETAILED DESCRIPTION OF PREFERRED EMBODIMENTS

The disclosed embodiments will now be described more fully hereinafter with reference to the accompanying drawings, in which certain embodiments of the invention are shown. The teachings of this application may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout.

In the following detailed description, the device, the method and the software product according to the teachings for this application in the form of a cellular/mobile phone will be described by the embodiments. It should be noted that although only a mobile phone is described the teachings of this application can also be used in any electronic device and preferably in portable electronic devices such as laptops, PDAS, mobile communication terminals, electronic books and notepads and other electronic devices offering access to information.

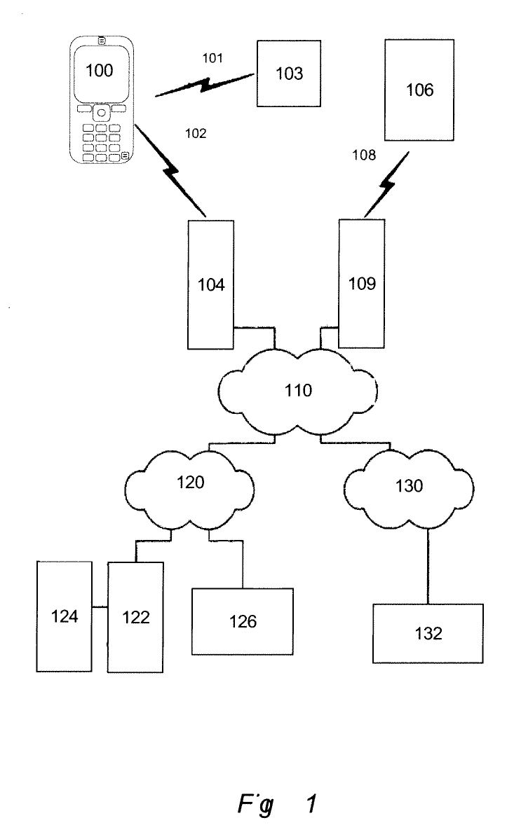

FIG. 1 illustrates an example of a cellular telecommunications system in which the invention may be applied. In the telecommunication system of FIG. 1, various telecommunications services such as cellular voice calls, www/wap browsing, cellular video calls, data calls, facsimile transmissions, music transmissions, still image transmissions, video transmissions, electronic message transmissions and electronic commerce may be performed between a mobile terminal 100 according to the present invention and other devices, such as another mobile terminal 106 or a stationary telephone 132. It is to be noted that for different embodiments of the mobile terminal 100 and in different situations, different ones of the telecommunications services referred to above may or may not be available; the invention is not limited to any particular set of services in this respect.

The mobile terminals 100, 106 are connected to a mobile telecommunications network 110 through RF links 102, 108 via base stations 104, 109. The mobile telecommunications network 110 may be in compliance with any commercially available mobile telecommunications standard, such as GSM, UMTS, D-AMPS, CDMA2000, FOMA and TD-SCDMA.

The mobile telecommunications network 110 is operatively connected to a wide area network 120, which may be Internet or a part thereof. An Internet server 122 has a data storage 124 and is connected to the wide area network 120, as is an Internet client computer 126. The server 122 may host a www/wap server capable of serving www/wap content to the mobile terminal 100.

A public switched telephone network (PSTN) 130 is connected to the mobile telecommunications network 110 in a familiar manner. Various telephone terminals, including the stationary telephone 132, are connected to the PSTN 130.

The mobile terminal 100 is also capable of communicating locally via a local link 101 to one or more local devices 103. The local link can be any type of link with a limited range, such as Bluetooth, a Universal Serial Bus (USB) link, a Wireless Universal Serial Bus (WUSB) link, an IEEE 802.11 wireless local area network link, an RS-232 serial link, etc. The local devices 103 can for example be various sensors that can communicate measurement values to the mobile terminal 100 over the local link 101.

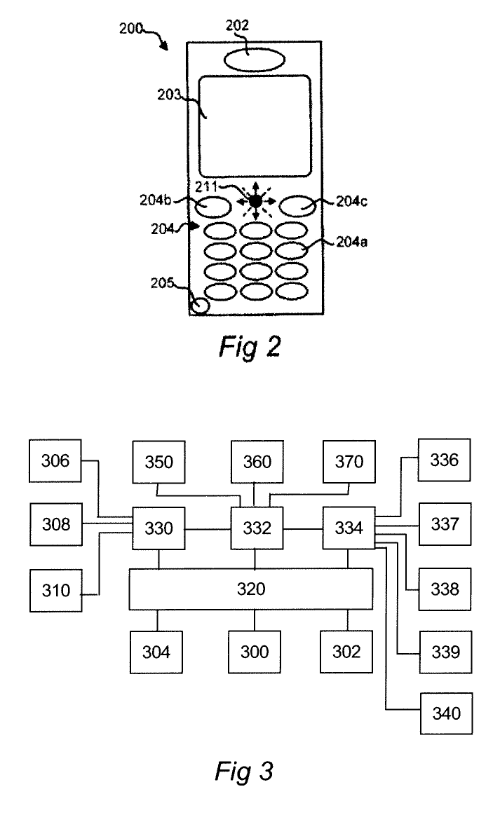

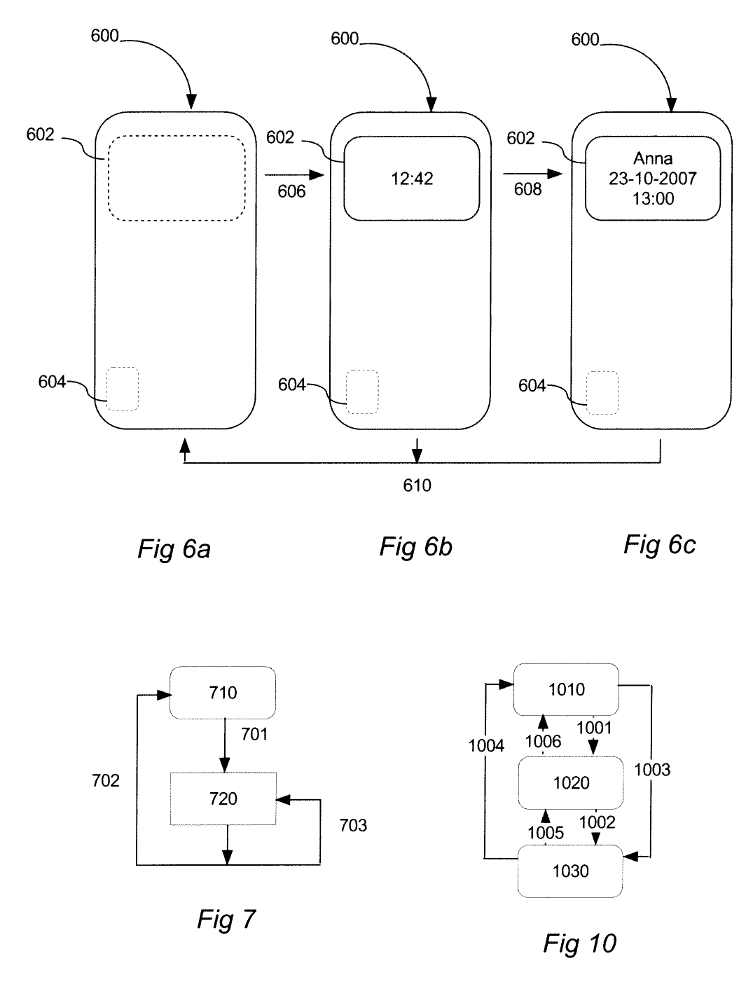

An embodiment 200 of the mobile terminal 100 is illustrated in more detail in FIG. 2. The mobile terminal 200 comprises a speaker or earphone 202, a microphone 205, a main or first display 203 and a set of keys 204 which may include a keypad 204a of common ITU-T type (alpha-numerical keypad representing characters “0”-“9”, “*” and “#”) and certain other keys such as soft keys 204b, 204c and a joystick 211 or other type of navigational input device. The mobile phone may also comprise an extra display, a secondary display arranged on the backside of the mobile phone 200 (shown in FIG. 6).

In the following a display will be referred to as being inactive when it or the display image on it is not visible to a user and it is not used to display any information or other data. A skilled person will realize that the display can still be functioning although at using less power than when it is active, i.e. the displayed image is visible to a user.

The internal component, software and protocol structure of the mobile terminal 200 will now be described with reference to FIG. 3. The mobile terminal has a controller 300 which is responsible for the overall operation of the mobile terminal and is preferably implemented by any commercially available CPU (“Central Processing Unit”), DSP (“Digital Signal Processor”) or any other electronic programmable logic device. The controller 300 has associated electronic memory 302 such as RAM memory, ROM memory, EEPROM memory, flash memory, or any combination thereof. The memory 302 is used for various purposes by the controller 300, one of them being for storing data used by and program instructions for various software in the mobile terminal. The software includes a real-time operating system 320, drivers for a man-machine interface (MMI) 334, an application handler 332 as well as various applications. The applications can include a personal exercise program or a calendar application 350,a media player application 360, as well as various other applications 370, such as applications for voice calling, video calling, sending and receiving Short Message Service (SMS) messages, Multimedia Message Service (MMS) messages or email, web browsing, an instant messaging application, a phone book application, a personal training application, a control panel application, a camera application, one or more video games, a notepad application, etc.

The MMI 334 also includes one or more hardware controllers, which together with the MMI drivers cooperate with the first display 336/203, the secondary display 340, the keypad 337/204 and a tactile command input detector or tap detector 338 as well as various other I/O devices 339 such as microphone, speaker, vibrator, ringtone generator, LED indicator, etc. As is known to a man skilled in the art the tap detector 338 can be implemented with for example an acceleration sensor. Pressure or shock sensors can also be used to detect a tap induced by a user. Additionally, a motion sensor 338 can be provided as the tap detector 338, being a sensor capable of detecting motion. The motion sensor could for example be a tilt sensitive sensor or an accelerometer being capable of sensing acceleration. The motion sensor 338 can be used for various purposes, such as user input, step counting, etc. As is commonly known, the user may operate the mobile terminal through the man-machine interface thus formed.

A tap in the context of the present application is generally a quick mechanical shock administered to a device and is signified in that it is indifferent of location and size as long as it is recognizable by the device. A tap can therefore be induced anywhere on the device or even near the device as long as it is strong enough to be registered by the device's tap detector.

The most straightforward implementation of a tap detector would be a movement sensor such as an accelerometer sensor arranged to send a signal to the controller 300 which determines what kind of tap it is.

Alternatively a shake could be construed to be a tap if a movement sensor such as an accelerometer is used for the tap detector.

The software also includes various modules, protocol stacks, drivers, etc., which are commonly designated as 330 and which provide communication services (such as transport, network and connectivity) for an RF interface 306, and optionally a Bluetooth interface 308 and/or an IrDA interface 310 for local connectivity. The RF interface 306 comprises an internal or external antenna as well as appropriate radio circuitry for establishing and maintaining a wireless link to a base station (e.g. the link 102 and base station 104 in FIG. 1. As is well known to a man skilled in the art, the radio circuitry comprises a series of analogue and digital electronic components, together forming a radio receiver and transmitter. These components include, band pass filters, amplifiers, mixers, local oscillators, low pass filters, AD/DA converters, etc.

The mobile terminal also has a SIM card 304 and an associated reader. As is commonly known, the SIM card 304 comprises a processor as well as local work and data memory.

In the below a mode is construed to be an implementation of a state, a composite state or collection of states in a device, such as a mobile terminal or mobile phone 400 or 600, depending on the complexity of the functionalities (if any) of the mode. A mode switch is thus a transit from one state to another state, both states possibly being composite states.

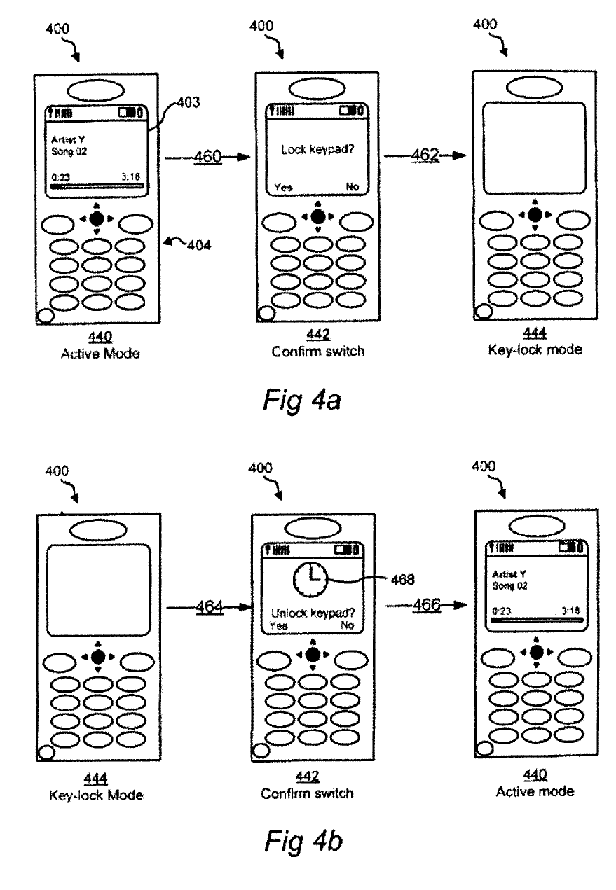

FIGS. 4a and 4b are a schematic diagrams showing how modes can be switched in the mobile terminal shown in FIG. 2.

In FIG. 4a, the terminal 400 is switched from an active mode 440 to a key-lock mode 444. The active mode is a mode in which the mobile terminal is active and all its inputs are active, such as keys 404, as well as outputs, such as the display 403.

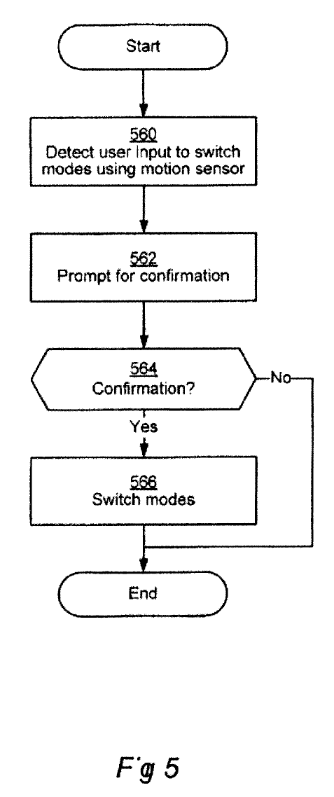

The user then moves the mobile terminal 400 in such a way that a mode switch user input 460 is detected, indicating that the user wishes to go to the key-lock mode 444. More details about this mode switch user input 460 are described in conjunction with FIG. 5 below. Consequently, because the user instructs the mobile terminal 400 to lock the keypad using motion detectable means, this can be also performed while running another application, such as writing a text message or listening to a music player.

As a response to the mode switch user input 460, the mobile terminal 400 enters a confirm switch state 442. Here the user is requested to confirm or reject the mode switch. In this embodiment, the user responds by confirming with the left soft key and rejecting with the right soft key. If the user presses the right soft key and rejects the mode switch, the mobile terminal returns to the active mode 440. On the other hand, if the user confirms 462 by pressing the left soft key, the mobile terminal enters the key-lock mode 444. In one embodiment, the user confirms by repeating the user input used for the mode switch user input, and rejection is effected by no input being entered within a time-out period.

Once in the key-lock mode 444, the display is inactive and key backlight (if available) is inactive, saving power for the mobile communication terminal. Additionally, if the display is a touch-sensitive display, the driver for the touch-sensor of the display is optionally inactive.

In FIG. 4b, the terminal 400 is switched from the key-lock mode 444 to the active mode 440, in a manner much like the switch from active mode 440 to key-lock mode 444 shown in FIG. 4a.

While in the key-lock mode 444, the user moves the mobile terminal 400 in such a way that a mode switch user input 464 is detected, indicating that the user wishes to go to the active mode 440. The mode switch user input 464 can be the same as the mode switch user input 460 mentioned above.

As a response to the mode switch user input 464, the mobile terminal 400 enters a confirm switch state 442. Here the user is requested to confirm or reject to go to the active mode 440. Optionally, the display may in this mode show a clock 468 (analog or digital). Consequently, there is an easy way for the user to check the time by simply performing the mode switch user input 464. This reduces the need for showing a clock in the key-lock mode, thereby saving power. In this embodiment, the user responds by confirming with the left soft key and rejecting with the right soft key. If the user presses the right soft key or a time-out period of no activity expires, the mode switch is rejected and the mobile terminal returns to the key-lock mode 444. On the other hand, if the user confirms 466 by pressing the left soft key, the mobile terminal enters the active mode 440. In one embodiment, the user confirms by repeating the user input used for the mode switch user input 464.

Once in the active mode 440, the display and key backlight (if available) are again active. Additionally, if the display is a touch-sensitive display, the driver for the touch-sensor of the display is active.

FIG. 5 is a flow chart illustrating a mode switch in the terminal of FIG. 2. The process illustrated in this flow chart is applicable both to a switch from the active mode to the key-lock mode and vice versa.

In a detect user input to switch modes using motion sensor step 560, the mobile terminal 400 detects the mode switch user input using the motion sensor 338 (FIG. 3).

The mode switch user input should be distinguishable from regular motions incurred while carrying the mobile terminal e.g. in a pocket or handbag. In one embodiment, the mode switch user input is a distinct single tap. Signal processing may be used to distinguish the single tap from regular motion of the mobile terminal. In one embodiment, the mode switch user input is a double tap, simplifying the distinction of the mode switch user input from regular motion of the mobile terminal. In one embodiment, the mode switch user input is a sequence of movements, e.g. tilt phone left, tilt phone right, tilt phone back. It is to be observed that any other suitable motion can be used for the mode switch user input; the invention is not limited to the examples mentioned above. In one embodiment, the mode switch user input is a tap on the display, the display being a touch sensitive display.

In a prompt for confirmation step 562, the user is queried whether the mode switch indicated by the mode switch user input is to be effected. For example, a message is shown on the display prompting the user if the keypad is to be locked (if the mobile terminal is initially in active mode) or unlocked (if the mobile terminal is initially in key-lock mode). Optionally, as described above, a clock can be displayed at the same time. Moreover, tactile feedback can optionally be given to the user, for example a single pulse vibration alert, giving the user clear feedback that the mobile terminal has understood the input to switch modes.

In a conditional confirmation step 564, the user either confirms or rejects the mode switching. The user can confirm, e.g. by pressing a soft button associated with confirmation, a voice command, a specific motion of the mobile terminal such as the motions described above in conjunction with step 560, etc. The user can reject e.g. by pressing a soft button associated with rejection, a voice command, a specific motion of the mobile terminal, etc. Optionally, if no user input is detected within a time-out period, it can be interpreted as a rejection. The time-out period can for example be 5s, 10s, or any other suitable time period. If the user confirms the mode switch, the process continues to a switch modes step 566. On the other hand, if the user rejects the mode switch, the process ends and the mobile terminal remains in the mode that the mobile terminal was in when this process was started.

It is to be noted that the prompt for confirmation step 562 and the conditional confirmation step 564 are optional steps.

In the switch modes step 566, the mode is switched. More specifically, if the initial mode was the active mode, the mobile terminal is switched to key-lock mode and if the initial mode was the key-lock mode, the mobile terminal is switched to the active mode. Optionally, tactile feedback can again be given to the user, for example a double pulse vibration alert, giving the user clear feedback that the mobile terminal has understood the confirmation to switch modes. After this step the process ends.

It is to be noted that although in the embodiment described above, it is described mode switches between an active mode and a key-lock mode, the invention is not limited to mode switches between these modes; the invention can be applied to any suitable mode switch for example from an idle or rest state to an information providing mode.

FIG. 6 shows the backside of mobile phone 600 as described with reference to FIGS. 2 and 3 that is in a rest or idle mode. A mode is in this context equivalent to a state. A secondary display 602 is arranged to be hidden when it is not activated.

Hidden displays such as this are known from mobile phones such as Nokia 7280® and Nokia 7380®. When a display of this type is not activated it is not visible and usually hidden under another surface like a mirror. As the display is activated it lights up and illuminates through the upper surface thus rendering it visible to a user.

A tap detector or motion sensor 604 (338 in FIG. 3) is also arranged in the mobile phone 600. The tap detector 604 is shown in dashed lines as it is part of the internal circuitry of the mobile phone and not visible as disclosed above. Upon detection of a tap command or tap a detection signal is generated and processed by the controller (300 in FIG. 3) of the mobile phone 600. It should be understood that the tap detector 604 could comprise both a sensor for detecting the physical tap and a controller for differentiating between different physical taps, which controller could be the same as the controller 300 of the mobile phone 600.

As a tap to the phone is detected by the tap detector 604 the mobile phone 600 assumes a mode or state providing information and the secondary display 602 is activated through transition 606 and illuminated as can be seen in FIG. 6c. The secondary display 602 will thus display the time of the day as given by a clock or calendar application (350 in FIG. 3). It is thereby easy for a user to activate the mobile phone 600 to show the time of day without having the secondary display being turned on all the time thus reducing the power consumption of the device. It is also easily and intuitively done as a user only has to tap the mobile phone 600 and does not need to open it or activate it by hitting any keys (204 in FIG. 2) which would require a controlled and precise movement by the user.

In one embodiment a confirmation message is displayed as a first tap has been detected asking the user to confirm that the device is to transit from the idle mode or state to the information providing mode or state by a further user action such as another tap.

Below is an illustrative example of how a mobile phone 600 according to the embodiment above can be used. A user is sitting by a desk working frantically on a paper. He wants to know the time and instead of having to pick up the mobile phone 600, press the correct button to activate it to show the time, he merely gives the mobile phone 600 a quick tap and it automatically lights up and displays the time of day as above. In fact, a quick thump or rap on the table would suffice as it would generate a shock that would be propagated through the table surface to the mobile phone 600 resting upon it and this shock would be detected by the tap or shock detector 604 implemented through a motion sensor and the mobile phone would be activated and the secondary display 602 caused to display the time of day.

In an alternative embodiment a further tap 608 detected by the tap detector 604 causes the mobile phone 600 to enter a second mode or state and the secondary display 602 to display a notification stored in a memory (302 in FIG. 3) of the mobile phone 600. This notification can be a calendar notification being provided by a calendar application (350 in FIG. 3). In FIG. 6c the calendar notification states that there is an upcoming appointment on Oct. 23, 2007 with Anna at 13:00.

Returning to our illustrative example our user realizes that there is something he has forgotten, a meeting, but he does not remember exactly when the meeting was scheduled for. Another quick tap on the mobile phone 600 or thump on the table will be detected by the tap detector 604 and cause the secondary display 602 to display the calendar notification informing him that he has a meeting with Anna on the 23 of Oct. 2007 at 1 pm.

Other notifications that could be displayed are status reports of incoming calls, missed calls, received messages (SMSes, MMSes, emails etc), Bluetooth™ activity, Wireless Local Area Network (WLAN) activity, General Packet Radio Service (GPRS) activity, Global Positioning System (GPS) coordinates, download status or a special message fetched by a specially adapted application for example arranged to show cartoons according to preset parameters.

In any of the states the mobile phone 600 will transit 610 to its idle or rest state after a time out value has lapsed without any user-activity.

It should be understood that the taps mentioned above can also be a double tap or a shaking movement either determined by a criteria such as having an approximately steady frequency, an amplitude above a certain threshold value or a prolonged duration or a combination of two or all three of these criteria.

FIG. 7 shows a basic flow chart for the activity of the mobile phone 600 in FIG. 6. The mobile phone 600 starts in a rest state 710. As a tap is detected by a tap detector 604 the phone transits to a state providing information 720, trough a transition 701, in which the secondary display 602 is activated and caused to display some information. A time out counter (not shown) is started. As the time out value is reached the mobile phone 600 returns to the idle state 710 through a transition 702 deactivating the secondary display 602. Any activity detected while in the state 720 resets the time out value through transition 703.

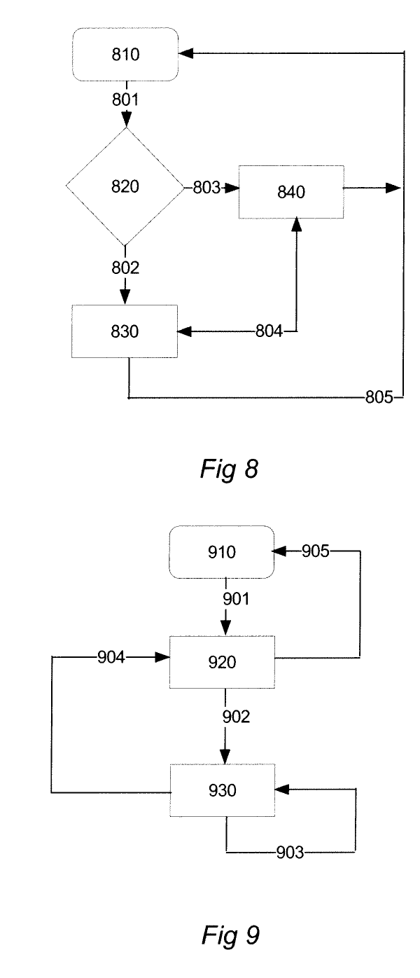

FIG. 8 shows an alternative flow chart for the activity of the mobile phone 600 of FIG. 6. The mobile phone starts in an idle state in step 810. As a tap is detected 801 the mobile phone transits into a state providing information in step 820 and the secondary display 602 is illuminated or activated. In the step 820 it is checked whether there are any notifications to display. If there aren't any the secondary display 602 is caused to display the time which is given by a watch or calendar application 350 in step 840 through transition 803. The action of displaying the time of day is thus a default action. If there are any notifications to display the secondary display 602 is caused to show a notification accordingly through transition 802 in step 830.

Alternatively the availability of the information to display determines which information is selected to be displayed. The amount of information pertaining to a specific notification could be a decisive factor in selecting which information to display. Or a time limit associated with the information could also be a decisive factor. For example, if there are 15 incoming SMS-messages the SMS notification will be displayed, but if there is a calendar event with a time limit about to be reached, the calendar event is judged to be more urgent and selected to be displayed. Furthermore, a priority scheme among the applications 350, 360, 370 could be a decisive factor. Thus a missed call notification could have a higher priority than an incoming SMS notification and be selected to be displayed first even if there are many more incoming messages. Alternatively the priority, the amount and the urgency could be used in a weighted function to determine which notification that should be selected to be displayed.

If a further tap is detected in any of steps 830 and 840 the mobile phone switches between these two steps and changes the information displayed on the secondary display accordingly through transitions 804.

If there is more than one notification to be shown the steps 830 and 840 could form a cyclic transition path with one step 830 for each notification and a user could thus scroll through the notifications one by one by inducing further taps or tapping the mobile phone 600. Alternatively the step 830 could show the various notifications upon a different or alternative tap and the watch could be reached by the single tap used to activate the mobile phone in step 820.

Furthermore, in both of steps 830 and 840 a time out counter is started and reset every time an action is detected. If the timeout counter reaches the timeout value it returns to the idle state in step 810 and deactivates the secondary display 602 through transition 805.

As explained above a tap can be a single tap, a double tap, a further repeated tap or a shaking action and more than one type of tapping can thus be used to control the device. A main tapping action, or simply put a tap, can therefore be used to control one function and an alternative tap can be used to control another function as will be seen below.

Most commonly, the more advanced the tap is the safer it is to assume that it has been done on purpose thus safe guarding from accidental taps. However, a more advanced or complicated tapping is more difficult for a user to achieve. A double tap is both easy to induce by a user and relatively safe to assume have not been accidental. Therefore a double tap could be used to transit from the idle state to a state providing information and a single tap could be used to control further actions. This would ensure that the device is easily woken up or activated by a deliberate command while maintaining a high usability level, i.e. ensuring that the device or mobile phone 600 is easy to use.

Which tap commands and what combinations that are to be used depend on usability aspects for the phone whether it is a heavy duty model or a fashion model etc as well as the intended user group and a combination of these and other factors.

The tap detector 604 can be arranged to produce different signals depending on the tap detected, thus being able to generate one signal for a single tap and one for a double tap etc. As stated above the tap detector can be part of the controller in connection with a sensor.

FIG. 9 shows a flow chart for a method providing alternative and further functionality to a mobile phone 600 as in FIG. 6. The mobile phone or device 600 starts in an idle state in step 910 and as an initiating tapping action, in this case a double tap, is detected the mobile phone 600 transits to a state providing information in step 920 through a transition 901. In this state the secondary display 602 is activated and caused to display both the time and notifications if any are available. Due to the limited size of the secondary display 602 the whole notification can probably not be displayed. Also if there is more than one notification all of them will most likely not be able to be shown at the same time on the secondary display 602. Instead small icons could be used to notify that there is further data or information to be presented to a user. For example a small letter symbol could be used to notify the existence of an incoming message, a small phone to notify that there has been voice call activities or a small calendar page to notify that there is an upcoming calendar appointment.

To access these notifications or if the user simply wants a larger view of the time display an alternative tap or a further tap can be used to scroll through these. As an alternative tap, in this case a single tap, is detected by a tap detector 604 in step 920 the mobile phone 600 transits to a new state in step 930 through a transition 902 and the secondary display is caused to show at least part of the content of a notification. If there are more than one notification and/or the notification is to big to be displayed at once on the secondary display 602 a further or yet an alternative tap, in this case a further single tap, causes the mobile phone to display the further information on the secondary display 602 in step 930 Through a transition 903. Repeated taps will cause the mobile phone 600 to display further information on the secondary display 602 through repeated transitions 903. This information can be a next notification, further information regarding the currently displayed notification or the time display.

In step 930 it is also possible that further activities or functions can be initiated, which activities or functions could be indicated on the secondary display 602, and the mobile phone 600 is thus in an active state where as in step 920 it is merely showing some information and therefore being in an information providing state.

For example, if an icon notifying that there is a missed call is displayed in step 920 a user can tap once to cause the device 600 to display details pertaining to the missed call, i.e. the phone number and an icon indicating that a call could be made to the number. A further double tap could be used to activate the corresponding function and thus place a call to the number displayed.

A timeout counter starts counting in step 930 and if there is no activity detected in step 930 the timeout counter reaches a timeout value the mobile phone 600 transits back to causing the display to show both time and notifications in step 920 through transition 904.

Also a timeout counter starts counting as step 920 is reached and if there is no activity detected in step 920 and the timeout counter reaches a timeout value the mobile phone 600 transits back to the idle state in step 910 through transition 905.

Alternatively a further single tap could be used to scroll through the notifications and an alternative tap could be used to display the time of day.

Also, a further alternative tap, like a shaking action could be used to rush any of the timeout counters causing them to transit the phone from state 930 to state 920 and/or from state 920 to state 910 through transitions 904 and 905.

FIGS. 7, 8 and 9 are combinations of state diagrams and flow charts describing a method each used to traverse the corresponding state diagram.

The mobile phone 600 has been described above as being a monoblock having one display on each side, but it should be understood that other form factors, such as slide, fold, twist, swivel and fold and twist can be used and that the displays can be mounted on any surfaces available.

It should also be noted that even though the mobile phone 600 above has been described as having a first and a second display, the teachings of this application also apply to a phone having one display and/or a main display being at least partially hidden.

The mobile phone 600 of FIG. 6 and the methods of the flowcharts of FIG. 7, 8 and 9 show a device and a method such a device having three states: IDLE 1010, INFORMATION 1020 and ACTIVE 1030. These states and the transitions between them are shown in FIG. 10. The device can be caused to transit between these three states by various actions such as tapping. The commands to be used depend on the physical form factor of the phone and for a fold or slide phone the command or action to transit from INFORMATION 1020 to ACTIVE 1030 trough transition 1002 or directly from IDLE 1010 TO ACTIVE 1030 trough transition 1003 could be to open the phone and then to transit back to IDLE 1010 or INFORMATION 1020 to close the phone trough transition 1004, 1005 or 1006. Or for a monoblock phone the commands could be: double tap to transit from IDLE 1010 to INFORMATION 1020 trough transition 1001, single tap to transit from INFORMATION 1020 to ACTIVE 1030 trough transition 1002 with timeouts to transit to the previous states trough transition 1004, 1005 or 1006.

In the ACTIVE state 1030 other functions could also be available, either through further or alternative tap input or through other keys such as keys 204 in FIG. 2. For example a first double tap transits the mobile phone from IDLE 1010 to INFORMATION 1020 and displays the notification for a missed call. If the user then taps a single tap the mobile phone 600 transits from INFORMATION 1020 to ACTIVE 1030 and displays the details regarding the missed call. A further double tap will cause the device to initiate a call to the number from which the missed call had been made. Naturally other command sequences could also be used.

In the IDLE state 1010 the keypad 204 could be locked in which case the IDLE state 1010 is a key-lock mode.

The mobile terminal 400 in FIG. 4 has two states, one open and one key-lock mode 444. The key-lock mode 444 is shown in FIG. 10 as the IDLE state 1010 and the active mode 440 as the 1030 ACTIVE state. A tap detected by the motion sensor 338 will cause the mobile terminal 400 to transit from IDLE 1010 directly to ACTIVE 1030 through transition 1003.

It should be noted that in all embodiments above it is also possible to combine the information providing states and the active state. Or in other words, the third state can be seen as being a sub-state of the second state. To illustrate by an example: if a user taps a mobile phone once a notification of a missed call is displayed possibly indicating that a call can be placed. A further tap will initiate a call to the number being displayed, thus combining the information providing state and the active state.

The various aspects of what is described above can be used alone or in various combinations. The teaching of this application is preferably implemented by a combination of hardware and software, but can also be implemented in hardware or software. The teaching of this application can also be embodied as computer readable code on a computer readable medium. It should be noted that the teaching of this application is not limited to the use in mobile communication terminals such as mobile phones, but can be equally well applied in Personal digital Assistants (PDAs), MP3 players, personal organizers or any other device designed for providing information while maintaining low power consumption. The teaching of the present application has numerous advantages. Different embodiments or implementations may yield one or more of the following advantages. It should be noted that this is not an exhaustive list and there may be other advantages which are not described herein. One advantage of the teaching of this application is that a device can be made to display information in a manner that is both power conservative and easy and intuitive to use.

Another advantage of the teaching of the present application is that a user can operate certain functions such as retrieving information from a device with only a simple and imprecise command or movement.

Although the teaching of the present application has been described in detail for purpose of illustration, it is understood that such detail is solely for that purpose, and variations can be made therein by those skilled in the art without departing from the scope of the teaching of this application.

For example, although the teaching of the present application has been described in terms of a mobile phone, it should be appreciated that the invention may also be applied to other types of electronic devices, such as music players, palmtop computers and the like. It should also be noted that there are many alternative ways of implementing the methods and apparatuses of the teachings of the present application.

The term “comprising” as used in the claims does not exclude other elements or steps. The term “a” or “an” as used in the claims does not exclude a plurality. A unit or other means may fulfill the functions of several units or means recited in the claims.

1. A device comprising a display and a tap detector capable of detecting a tap command from a user and arranged to generate a detection signal upon detection of a tap command, wherein said device is arranged to assume one out of a plurality of states including
an idle state, wherein said display is inactive, and
a second state, wherein said display is active and displaying information,
and said device is arranged to transit from said idle state to said second state upon generation of said detection signal.

2. A device according to claim 1 wherein said tap detector is a motion sensitive sensor.

3. A device according to claim 1 further arranged to change said information being displayed on said display upon further generation of said detection signal whilst the device is in said second state.

4. A device according to claim 1, wherein said information relates to any of: time, incoming message status, call history status or calendar events.

5. A device according to claim 1 further arranged to select which information to display according to availability of said information.

6. A device according to claim 1, further comprising a third state in which further information is displayed and said device is arranged to transit to said third state from said second state upon generation of an alternative detection signal.

7. A device according to claim 6, wherein said information being displayed in said second state is different from said further information being displayed in said third state.

8. A device according to claim 6, wherein said second state is an information providing state in which said device is arranged to display information and said third state is an active state in which said device is arranged to receive further commands associated with functions of said device.

9. A device according to claim 1, wherein said device is comprised in a mobile communication terminal.

10. A method for providing a user interface of a device having a display and a tap detector comprising:
starting in an idle state wherein said display is inactive,
detecting a tap,
entering a second state, and
causing said display to display information.

11. A method according to claim 10, wherein said tap detector is a motion sensitive sensor.

12. A method according to claim 10 further comprising detecting a further tap and causing said display to change said information being displayed.

13. A method according to claim 10 further comprising selecting said information to be displayed according to availability of said information.

14. A method according to claim 10 further comprising:
detecting a further or alternative tap,
entering a third stage, and
causing said display to display further information.

15. A method according to claim 14, wherein said further information pertains to an activity or a function associated with said and said method further comprises detecting a tap and executing said activity or function.

16. A device comprising tap detector means, display means and information storing means, wherein said device comprises means for:
assuming an idle state in which said display means are inactive, or
assuming a second state, wherein said display means are active and arranged to display information form said information storing means,
wherein said detector tap means are arranged to:
switch said device from said idle state to said second state upon detection of a tap.

17. A computer readable medium stored in a memory including at least computer program code for controlling a device comprising a display, tap detector, said computer readable medium comprising:
software code for receiving input through said tap detector,
software code for activating said display upon receiving input from said tap detector, and
software code for causing said display to display information.

18. A device incorporating and implementing a computer readable medium according to claim 17.

19. An apparatus comprising:
a display;
a motion sensitive sensor; and
a controller;
wherein said controller is configured to detect, using said motion sensitive sensor, a first user input; and
said controller is further configured to, as a response to said first user input, activating said display and presenting a clock on said display.

20. An apparatus comprising:
a display;
a motion sensitive sensor;
a controller;
means for detecting using said motion sensitive sensor, a first user input; and
means for, as a response to said first user input, activating said display and presenting a clock on said display.

21. A method for providing a user interface of a mobile communication terminal comprising a motion sensitive sensor, and a display, said method comprising:
detecting using said motion sensitive sensor, a first user input; and
as a response to said first user input, activate said display and presenting a clock on said display.
